(19) United States
(12) Patent Application Publication
(10) Pub. No.: US 2018/0342020 A1
(43) Pub. Date: Nov. 29, 2018

(54) SYSTEM, METHOD AND APPARATUS FOR MANAGEMENT OF AGRICULTURAL RESOURCE

(71) Applicant: REMOTE GRID PTE. LTD., Singapore (SG)

(72) Inventors: Indranil SEN, Singapore (SG); Debapriya DASGUPTA, Singapore (SG); Avish JOSEPH, Singapore (SG); Anupam BHATTACHARYA, Singapore (SG); Mohan KANKANHALLI, Singapore (SG); Stuart BROWN, Singapore (SG)

(73) Assignee: REMOTE GRID PTE. LTD., Singapore (SG)

(21) Appl. No.: 15/607,600

(22) Filed: May 29, 2017

(30) Foreign Application Priority Data
May 24, 2017 (SG) 10201704222V

(51) Int. Cl. G06Q 50/02; G06Q 10/06

(52) U.S. Cl. CPC G06Q 50/02; G06Q 10/06375; G06Q 10/06315

(57) ABSTRACT

A system for managing an agricultural resource comprising an input module arranged to receive inputs from a plurality of input sources; a central processor arranged in data communication with the input module to generate at least one long term forecast; the central processor further configured to receive inputs from selected input sources at a predetermined time to adjust a parameter of the at least one long term forecast to derive a short term forecast; and an output module arranged in data communication with the central processor to receive the long term forecast and/or the short term forecast for decision control; the output module arranged in data communication with at least one output device, is disclosed.

This application claims priority to the Singapore Patent Application No. 10201704222V filed on May 24, 2017, the content of which is incorporated by reference in its entirety by reference.

### FIELD OF THE INVENTION

The present invention relates to a system, method and/or apparatus for management of one or more agricultural resources.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

The agricultural industry is traditionally a labor intensive industry. Farmers are preoccupied with taking care of their crops or agricultural produce taking into account weather, soil condition, irrigation, temperature, pests, amongst others. Most farmers rely on expertise, tacit knowledge or ‘know-how’ handed from one generation to another.

With the advent of sensor, network and software technology it is now possible to achieve greater agricultural yield using minimal resources. Termed ‘precision agriculture’, resources like water, fertilizer and pesticides may be better managed to provide the highest crop yield possible. Its positive side effects are potential low overall costs, low environmental damage and better produce quality.

Presently there exist systems that utilize sensor, network and software technology to manage agricultural resources such as farms. An example of such as system is described in published U.S. Pat. No. 9,292,796A1, which discloses a harvest advisory modeling system using field-level analysis of weather conditions, observations and user input of harvest condition states, wherein a predicted harvest condition includes an estimation of standing crop dry-down rates, and an estimation of fuel costs. Notwithstanding the aforementioned example, there exists a need to develop a comprehensive system which extends beyond mere prediction of harvest condition and advisory modeling, and in particular will include other conditions and input associated or affecting agricultural resource management.

The present invention seeks to meet the aforementioned needs at least in part.

### SUMMARY OF THE INVENTION

Throughout the document, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The present invention seeks to provide a cost-effective agriculture management solution operable to reduce the labour-intensiveness of the traditional farm management. The technical solution includes an input/output module operable to receive structured and unstructured data, a central management server (central processor) operable to process the structured and unstructured data to provide output decisions relating to agricultural management, including soil pH, soil moisture, suitable type of crop to plant, amount of irrigation, amongst others. These output are sent to actuators deployed around or in specific agricultural areas. The present invention also seeks to provide multiple levels of fusion between the structured and unstructured data before the central management server classify the inputs for generation of long term and short term forecasts.

In accordance with an aspect of the invention there is a system for managing an agricultural resource comprising an input module arranged to receive inputs from a plurality of input sources; a central processor arranged in data communication with the input module to generate at least one long term forecast; the central processor further configured to receive inputs from selected input sources at a predetermined time to adjust a parameter of the at least one long term forecast to derive a short term forecast; and an output module arranged in data communication with the central processor to receive the long term forecast and/or the short term forecast for decision control; the output module arranged in data communication with at least one output device. In some embodiments, the inputs comprise at least one structured input and at least one unstructured input.

In some embodiments, the at least one structured input and at least one unstructured input are fused at a feature level or a decision level to form a pre-processed input.

In some embodiments, the plurality of input sources comprise at least two of the following: weather sensor, soil moisture sensor, soil pH sensor, water sensor, soft sensor, terrain map, images of environment, data associated with at least one social network.

In some embodiments, the parameter to be adjusted comprises at least one of the following: fertilizer application, irrigation plan, and crop protection methodology.

In some embodiments, the generation of long term forecast comprises at least one of the following decision parameters: seed type selection, fertilizer application, irrigation plan, crop protection.

In some embodiments, the output module comprises an omni-channel interface comprising a plurality of output channels. The plurality of output channels may comprise two or more of the following:—short message system (SMS) message, electronic mail, web or desktop app, mobile application, application programming interface, geographical information system, chatbot.

In some embodiments, the central processor comprises a descriptive module, a predictive module and a prescriptive module. The descriptive module may comprise at least one of the following sub module:—a visualization module, an alert module, and a reports module.

In some embodiments, the long term forecast or short term forecast is generated using at least one of the following: a basic rule simulator, a classification and regression tree, and a deep learning algorithm.

In some embodiments, the prediction of the at least one parameter comprises one or more of the following:—soil data interpolation, hyper local weather forecast, yield estimation, pest and disease forecast.

In some embodiments, the input module comprises a mobile computing device arranged to send at least one structured input or at least one unstructured input to the central processor, the mobile computing device further arranged in data communication with the at least one output device.

In some embodiments, the inputs are selectively labelled for classification using an adaptive sampling methodology, the adaptive sampling methodology comprises an estimation of one or more of the following: a function, a concept, an incident.

In accordance with another aspect of the invention there is a method for managing an agricultural resource comprising the steps of:
a. generating at least one long term forecast;
b. collecting at least a structured data and an unstructured data;
c. receiving and pre-processing the structured and unstructured data by a central processor, the pre-processing step further comprises classifying and labelling the structured and unstructured data; and
d. adjusting the at least one long term forecast to derive a short term forecast based on the collected data at every predetermined interval.

In accordance with another aspect of the invention there is a non-transitory computer readable medium containing executable software instructions thereon wherein when executed on a mobile device and/or a computer device performs the method for agricultural management comprising the steps of:
a. generating at least one long term forecast;
b. collecting a structured data and an unstructured data;
c. receiving and pre-processing the structured and unstructured data by a central processor, the pre-processing step further comprises classifying and labelling the structured and unstructured data; and
d. adjusting the at least one long term forecast to derive a short term forecast based on the collected data at every predetermined interval.

### BRIEF DESCRIPTION OF THE DRAWINGS

The present invention will now be described, by way of example only, with reference to the accompanying drawings, in which:

FIG. 1 is the overall architecture of an embodiment of the invention showing how the various parts of the system interact;

FIG. 2 is a flowchart of an embodiment of the invention showing how a method of agricultural management according to some embodiments; and

FIG. 3 illustrates another embodiment of the invention.

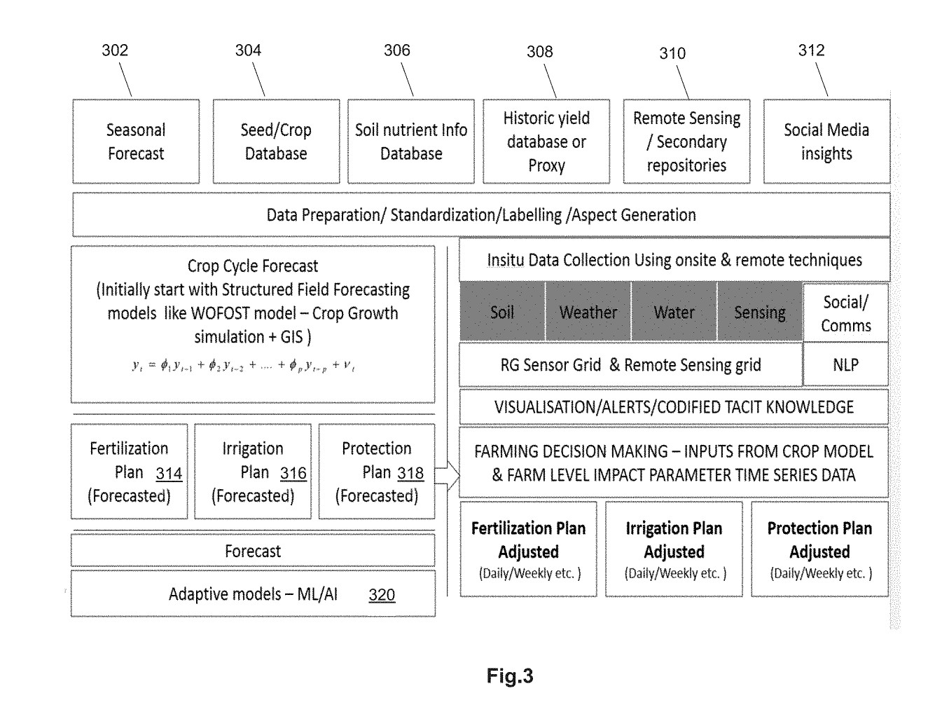

### DETAILED DESCRIPTION

Particular embodiments of the present invention will now be described with reference to the accompanying drawings. The terminology used herein is for the purpose of describing particular embodiments only and is not intended to limit the scope of the present invention. Additionally, unless defined otherwise, all technical and scientific terms used herein have the same meanings as commonly understood by one of ordinary skill in the art to which this invention belongs.

Throughout the description, the term ‘agricultural resource’ may include farms or plantations in various forms, such as, but not limited to, vertical, horizontal, inclined farms at different geographical locations.

It is to be appreciated that the present invention may be utilized for predictive and prescriptive support of an agricultural resource. Predictive and prescriptive support include the generation of a long term forecast across the time period of multiple crop cycles, and short term forecast within the time period of one crop cycle or shorter. It is therefore appreciated that the period considered for ‘long term’ and ‘short term’ varies across different crop types. In particular, ‘long term’ may range from weeks to months, and ‘short term’ may range from minutes, hours to days.

According to an aspect of the invention there is a system for managing an agricultural resource comprising an input module arranged to receive inputs from a plurality of input sources; a central processor arranged in data communication with the input module to generate at least one long term forecast; the central processor further configured to receive inputs from selected input sources at a predetermined time to adjust a parameter of the at least one long term forecast to derive a short term forecast; and an output module arranged in data communication with the central processor to receive the long term forecast and/or the short term forecast for decision control; the output module arranged in data communication with at least one output device. The arrangement forms an analytical framework for agriculture and may be customized based on inputs such as, but not limited to, geographical location, soil and crop information. The inputs may collectively be referred to as ‘nodes’ and the output dataset are sent to output devices or actuators. Some actuators (such as physical sensors) may also be input sources. It is thus appreciated that a feedback loop can be formed between the input and output modules. Examples of output devices or actuators may include irrigation controllers not limited to water sprinklers/sprayers, soil mixer, seed drills, forage harvesters, etc. At least one output device may be ‘smart’ device equipped with wireless communication capabilities or module capable of being switched on or off by a computing device.

Over time, the system collects data from the input sources and output devices (where applicable) to form the knowledge database. Such knowledge database may comprise one or more databases (distributed or otherwise) arranged in data communication with the central processor to provide data support to the system for agricultural management. Data within the knowledge base may be grouped or classified into at least two groups. Example of groups comprise crop types, geographical location, amongst others. Such groupings may be performed by known classification or grouping techniques, including artificial intelligence techniques such as self-organization maps, support vector machines, neural networks etc.

The data are processed by the central processor to generate a long term forecast and derive at least one short term forecast. The short term forecast may be derived based on adjustments to one or more parameters of the long term forecast.

Information delivery to one or more users, such as plantation owners, may be done via multiple channels, also referred to as ‘omni-channels’. The information are sent in the form of electronic alerts, status reports and reminders to the user. In a “bidirectional flow” model, users receiving the information are able to interact using one or more of the “omni-channels” and able to take actions needed based on the information received (or able to create conditional settings in the system as a response to the information received). For example, the information may comprise short term adjustments in the form of electronic instructions activate one or more irrigation relay systems when soil temperature is above certain limits and need to be decreased based on the ambient growing conditions. Other examples include sending of electronic messages, electronic mails, and electronic alerts to one or more users or managers of the agricultural resources informing them of certain activities or actionable instructions.

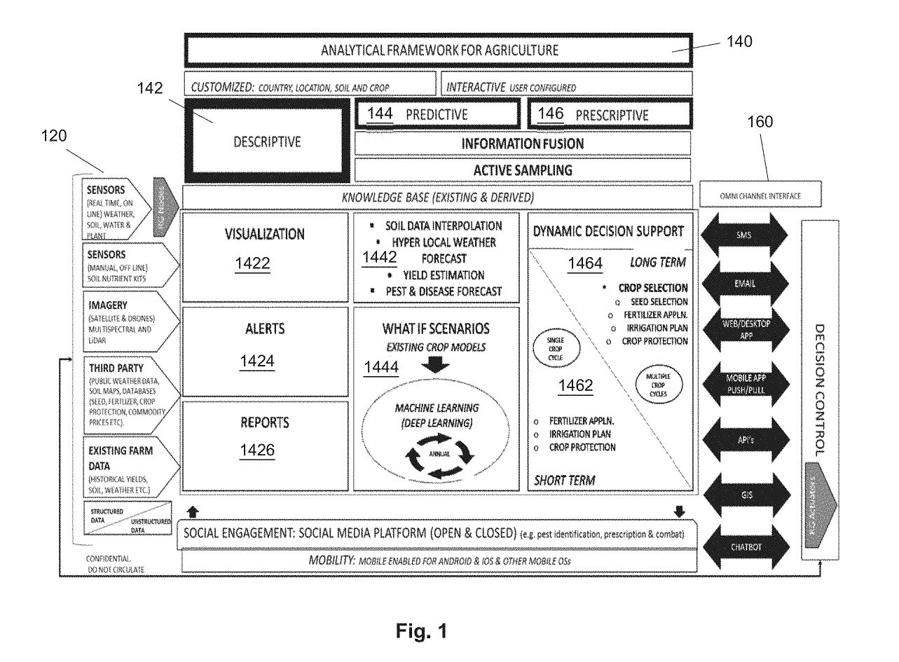

With reference to FIG. 1, the system 100 comprises a plurality of input sources 120 forming the input module. The input sources may comprise physical sensors such as weather sensors, soil composition sensors, humidity sensors, wind speed sensors, rainfall sensors, water pH sensors etc. disposed or positioned in one or more agricultural resources such as farms to measure important parameters such as water temperature, water pH, water conductivity, internal temperature of specific areas, dissolved oxygen in water, battery life of individual sensors etc. These inputs are to be provided at the appropriate amounts depending on crop type, temperature, climatic and environmental conditions, which are necessary for healthy growth of crop, plants or produce. The input sources 120 may comprise soft sensors, image data and third party information obtainable from social network, collaborators, weather drones/terrain vehicle, satellites arranged in communication with the system 100.

Historical data or existing data obtained from a predetermined period stored in one or more computer readable medium, arranged in data communication with other input sources may be considered as input sources 120. In some embodiments, the historical data may include past yields, soil, and weather associated with the specific agricultural resource such as farm. In some embodiments, the collected quantitative data through the hard or soft sensors (weather, soil, irrigation water) at regular intervals related to various parameters are stored into the knowledge base.

In some embodiments, the input module may comprise a mobile computing device, such as a smart phone or tablet having a plurality of hardware modules installed thereon, each hardware module having capability to interact with one another and/or to obtain input. Examples of hardware module include an image and/or video capturing module such as a camera, a wireless communication module capable of communication in various communication protocols not limited to Bluetooth™, Wi-Fi, 4G etc. The mobile computing device may also include data obtained from accelerometers, gyroscopes, and radio-frequency identification (RFID) tags, and also be installed with one or more social network applications.

The mobile computing device may also be installed with a dedicated application, hereinafter referred to as ‘RGapp’. The RGapp is operable to obtain input from various hardware modules on the smart phone for transmission to a central processor 140, and to receive data or electronic instructions from the central processor 140. The mobile computing device may further be equipped with locational-based device/module such as a global positioning system (GPS) module for sending and receiving location based data. The RGapp may also be used by a user to control or communicate with at least one output device. To facilitate the control or communication, the at least one output device may be equipped with wireless communication modules for communication with the mobile computing device.

Data from the input sources 120 will be sent to the central processor 140 as input data. The input data received may be grouped or classified based on one or more of the following criteria, such as, but not limited to, geographical location (e.g. country and specific area within the country), type of soil, type of crop, etc. The input data may also be grouped according to user preference which may be provided via one or more interactive interface with users of the system 100, or via the RGapp. It is to be appreciated that the input data comprise structured and unstructured data. In some embodiments, the grouping or classification of inputs may be executed or performed on the mobile computing device.

Structured data may comprise a ‘signal data’ which include quantitative or quantifiable data collected in situ using sensors and devices deployed on the agriculture resource site, or may comprise remotely obtained dataset or data via visual analytics/statistical measurements, or may comprise combinations thereof. Such structured data may be numerical data classified in the form of scalars, vectors, images or videos etc. Examples of structured data may also include electronic data obtained from data sources such as those listed as follows.
(a) weather station which include in situ sensors;
(b) satellite which include images, videos;
(c) drone which include data & images; or
(d) physical sensors.

One or more of the aforementioned input data may be owned by an agricultural resource company.

In some embodiments, data obtained from third party source(s) may form at least part of the structured data sources. These third party source(s) include secondary sources, published reports, trackers etc. The structured data may be in the form of a text, image, rich text etc.

The unstructured data may include qualitative, unconventional and contextual data relevant to a particular situation or context. The unstructured data may also be quantitative or quantifiable data. The meaning of ‘unstructured data’ may change depending on context and some embodiments of the unstructured data may be in textual form of tags, phrases, paragraphs and articles. Examples of unstructured data include known social platforms not limited to Facebook™, Twitter™, Instagram™ etc. In these known social platforms, extraction and management of such unstructured data will include the development of relevant application programming interface as known to a skilled person for extracting, consolidating, cleansing and labelling social platform related data.

Unstructured data may also be obtained from shared sources through Social platforms—(via groups etc.), shared community sources (Blogs, Forums, chat groups etc.). Data from specific users known as influencers within the community and social space which will be validated and authenticity is established through social graph and related influencer scores.

In some embodiments, structured data are stored in normalized relational databases such as SQL™ database, Oracle™ database, and the unstructured data are stored in Hadoop Distributed File System (HDFS) environment which may distributed and stored in clusters of computer forming one or more networks, or in a Scala environment. Unstructured data typically needs to be analysed or converted into a meaningful form before it can be utilized. This may be based on natural language processing (NLP) techniques.

In some embodiments, the system 100 may comprise one or more servers operable to obtain unstructured data, in the form of feeds, from different social media networks or channels. Such feeds may be in the form of electronic alerts/signals provided in the form of push electronic messages or otherwise to agricultural resource owners or workers such as farmers in order to provide proactive decision making.

As the data obtained include multimedia such as images, videos, data, social network information, and therefore are likely to be multimodal, it is to be appreciated that both structured data or unstructured data may undergo certain pre-processing steps before classification. Such pre-processing steps may include multimodal data fusion involving feature extraction and data fusion at a feature level or decision level. Preferably, a hybrid fusion model may be adopted to take into account different data.

It is to be appreciated that in embodiments involving the use of one or more mobile computing devices as input modules, structured and/or unstructured data may be obtained from the mobile computing devices. These may be aggregated via the RGapp before the aggregated data are sent to the central processor 140. Fusion may also be performed on the mobile computing device. The structured and/or unstructured data may be stored for analysis by the central processor 140.

The central processor 140 comprises at least three modules:—a descriptive module 142, a predictive module 144 and a prescriptive module 146. Each input obtained from the input module 120 may be utilized in one or more of the modules 142, 144, 146.

The descriptive module 142 may be arranged in data communication with databases and user interface to provide visualization, alerts and reports for analysis. In some embodiments, the descriptive module 142 comprises user interface to receive real time inputs from analysts. In some embodiments, the visualization, alerts, and reports for analysis may be predetermined or set by the users or decided by the system 100. Some parameters are defined as necessary. For example, if the temperature goes above a certain predetermined threshold or the humidity goes below a certain predetermined threshold, then an alert will be send in the form of an SMS and/or APP Push or electronic mail in accordance with the preference settings predefined by the users. Omni-channels in this context are utilized as a media for disseminating information via web screens, SMS text, SMS voice, Email, App Push etc.

The central processor 140 operates to process the input information and classify them into descriptive, predictive and prescriptive information. These information may be stored in corresponding memory units associated with the three modules, arranged in data communication with the central processor 140. In some embodiments the memory units may be integrated with the central processor 140.

The visualization, alerts and reports may be implemented as sub-modules in separate memory units or computer readable mediums such as servers. The visualization sub-module operates to display variation of parameters or variables over predetermined time periods such as one day, one week or one month.

The alerts sub-module provides indicators or triggers when any of the measured parameters which has an impact on desired outcomes deviate above or below certain threshold level. In some embodiments, the alerts is set by a user of the system based on contextual intelligence or can be set based on published standards specific to a crop or geolocation or farming practice. Such alerts may be electronic notifications deliverable via electronic mail (Email), Short message service (SMS) message, voice call or electronic message via push technology (such as App push).

The predictive module 144 comprises a forecast sub-module 1442 and a scenario generator 1444. Forecast sub-module 1442 utilizes machine learning techniques such as regression techniques, decision trees and support vector machines (SVM) or deep machine learning to generate long term and/or short term forecasts which may relate to soil data interpolation, hyper local weather, yield estimation, pest and disease forecast etc.

The scenario generator 1444 generates scenario based studies based on different crop models.

The prescriptive module 146 comprises a dynamic decision support module. The dynamic decision support module also comprises a long term dynamic decision support module 1464 and a short term dynamic decision support module 1462. The long term dynamic decision support module 1464 is associated with crop selection parameters including, but not limited to, seed selection, fertilizer application, irrigation plan and crop protection for multiple crop types, hence in effect relates to multiple crop cycles. The short term dynamic decision support module 1462 relates to a single crop cycle and includes one or more of the following short term parameters:—fertilizer application, irrigation plan, crop protection etc.

In some embodiments, the system 100 may be utilized such that the long term dynamic decision support module 1464 is utilized first to generate a long term schedule such as an irrigation plan, fertilizer application plan and/or a crop protection schedule for multiple crop cycles. The short term dynamic decision support module 1462 may be then utilized to complement the long term schedule to generate a short term schedule (which may be a few days in advance, a few hours in advance, a few minutes in advance, or a few seconds in advance) to adjust parameters associated with the long term schedule based on real time conditions. Such adjustment based on actual conditions may be real time or near real time based with feedback obtained from the input (such as physical sensors) to adjust or fine-tune parameters such as nitrogen content, potassium based on actual weather forecast, new disease(s), likely impact of crop cycle, online advisory, etc.

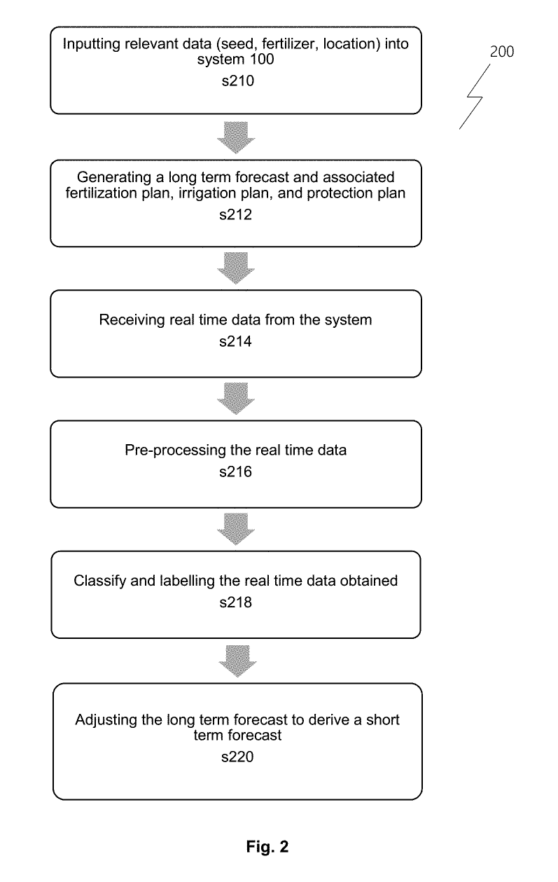

FIG. 2 shows another embodiment of the invention. The structured and unstructured data collected are classified into various types, such as seasonal forecast 302, seed/crop 304, soil nutrient information 306, historical yield 308, remote sensing/secondary repositories 310, and social media insights 312. The data may be fused prior to classification or after classification. Further pre-processing such as data preparation, data standardization, data labelling, and aspect generation may be performed. In the further data manipulation, the structured and/or unstructured data may be fused or combined using fusion algorithms.

The generation of long term or short term schedules may utilize a known crop model, which is a simulation model that helps estimate crop yield as a function of weather conditions, soil conditions, and choice of crop management practices. Such crop cycle forecast may be obtained via simulation models such as World Food Studies (WOFOST), Agricultural Production Systems Simulator (APSIM), CropSyst, Decision Support System for Agrotechnology Transfer (DSSAT), Environmental Policy Integrated Climate (EPIC), SWAP etc. It is to be appreciated that the different simulation models may be utilized for the quantitative analysis of the growth and production of annual field crops. The simulation model may be supplemented by a geographic information system. The simulation models may also be supplemented with hyper local data inputs thereby enhancing the accuracy of the estimated outcomes.

In some embodiments, the crop cycle forecast include the generation of a fertilization plan 314, an irrigation plan 316, and a protection plan 318 (for example pest control). The generation of the forecasts and plans may be supplemented by the utilization of adaptive models such as machine learning and artificial intelligence models 320.

In the implementation of any long term forecast, structured and unstructured data are still collected from selected sensors continuously or at predetermined intervals by the system 100 using onsite or remote techniques. Real time decision making at a farm may be subjected to change based on incoming data, such as time series data collected. For example, if the forecasted irrigated plan stipulates certain volume of water to be provided to the crop at a particular time but actual soil sensors detect high level of water content in the soil at a time (e.g. 3 hours) before the implementation of the irrigation plan, the irrigation plan (short term plan) may be modified such that the water volume for irrigation may be reduced by an amount. The actual water amount to be reduced for irrigation may depend on crop type and/or actual water content in the soil.

In some embodiments, non-structured data related to social platforms such as community forums may be extracted using web crawlers, after which such data are processed via known data cleansing and standardization techniques. Neural linguistic programming (NLP) techniques based on Semantic Analysis of Social Media (SASM) may be deployed. For contextual interpretation, at least one lexicon dictionary associated with agriculture (hereinafter referred to as Agri Lexicon reference dictionary) for contextual interpretation may be utilized. Relevant information or intelligence of social data may be obtained by overlaying the SASM with the Agri Lexicon reference dictionary, which may be modified to accommodate or suit hyperlocal context. For example, location specific organic fertilisation for tomato plantation may be based on soil characteristics or location specific pest infestation (the pest names, disease names are detailed in the Agri Lexicon reference dictionary). The processed unstructured data may then be analysed based on the NLP techniques to create features. Features may be used to determine whether a typical crop is diseased. Using tomatoes as examples, input sources such as wilting images and/or posts/comments shared by a social community will be subjected to an image analysis and feature generation such as (i) phrases used such as ‘drooping’, ‘wilting’ leaves may indicate “diseases” in the posts/comments; and (ii) images containing spots or rashes on the leaves may be identified from the shared photos. Features can be generalised over a period of time or by overlaying with the Agri lexicon for tomato category.

In various embodiments, the generation of long term and/or short term forecasts and decision making may evolve depending on the amount of data collected. When the system 100 is operating at the outset, a simulation model (e.g. APSIM or WOFOST) may be used as a basic fixed rule model for generation of forecasts. As the data collected from the input sources increase, the generation of forecasts (prediction) and decision (prescriptive) may evolve to the use of one or more classification and regression trees (CART) for classification of the inputs and outputs. Further data collected will involve the use of deep learning algorithms for correlation and classification based on supervised or unsupervised learning. In some embodiments, the deep learning algorithms comprise one or more neural networks having multiple layers. The CART and deep learning algorithms will be superior to the basic fixed rule model, providing the fixed rule model with adaptive capabilities. It is to be appreciated that the classified dataset may be labelled with tags which can be further analysed using exploratory techniques to provide insights to the agricultural or farming community.

In some embodiments, the structured and unstructured data in the predictive and/or prescriptive modules 144, 146 may be processed to form a fused input dataset. The combination or fusion of structured and unstructured data or information is advantageous in the system 100. This may be in part due to the fact that the ‘signal data’ provide partial picture from an application point of view and there is a need for metrics and measurements to be contextually interpreted. Combining or fusing the ‘signal data’ with the ‘symbolic data’ collected through various social and community channels will bridge the gap of meaningful interpretation and application of information for farming practices. Such an arrangement, i.e. the ‘fusion’ or ‘combination’ of numeric (signals) and symbolic unstructured data (symbolic text) information using statistical and natural language processing (NLP) techniques advantageously facilitate representative learning for gaining meaningful, actionable insights.

The outcome of such fusion or combination of information leads to suggestion or suggested solutions based on at least two categories of data. This may provide a more comprehensive solution that in turn provides a reassurance to farmers or users to follow certain techniques/methodology/farming decisions conducive to their hyper local environment.

In some embodiments, where learning (supervised or unsupervised) is employed or deployed, the backend learning methodology or algorithm may include one or more ranking functions. The one or more ranking functions operate to provide a rank associated with each training set to generate a quantitative score that can later be used to rank new similar subjects. As an example, to discover the incidence of a rare pest infection for rice fields, unless a good quality pre-labelled training dataset is available, the probability to detect such pest infestation is relatively low. Producing detailed labelled training sets is usually very costly as it requires human annotators to assess the relevance or order the elements in the training set.

To reduce computational or financial cost, the system 100 may comprise an alternative approach for labelling of data. Such an approach involves the use of adaptive sampling that will reduce the labelling effort by selectively sampling an unlabelled training set instead of using human annotators to label the training set one by one. The methodology depends on estimating a function/concept/incident, as fast as possible, by strategically focusing on the most informative regions of interest. New sampling locations are decided using information gathered from the previous observations.

The initial few sample locations are chosen a priori (which may be at random), before any observations are made. Adaptive sampling then acquires data incrementally, at each phase identifying new sampling locations that are most informative. The smaller the number of sampling locations, the more dissimilar and more “informative” are the samples. This is contrasted to the alternative in which uniform over-sampling is done which requires more effort. Adaptive sampling makes the application more efficient in identifying near to accurate trends and results. It also helps achieve statistically valid conclusions using smaller sample sets.

In some embodiments, the prescriptive module 144 may comprise a plurality of agricultural resource practitioners sharing their credence knowledge within a platform arranged in data communication with the central processor 140. The platform may be a social platform comprising groups, community forums etc. A model to incentivise users for their participation may be included to encourage participation. Once practitioners gets engaged in a social platform, many issues previously identified which require prescriptive advice may be sought through the social platform, which can be an input module within the system 100. The participating practitioners can be later categorized based on social graph and influencer authenticity scores like ‘Klout’ score. The participants may include scientists, professors, and even experienced farmers sharing experiences/solutions facing similar circumstances.

As an illustration of the use of the system 100, a group of tomato farmers engaged through online/social platforms (including forums, network or community groups), sharing their farm information like photos images of their wilted tomato leaves, or posting/comments on the drooping of leaves in their tomato plantation via their mobile computing devices for example, will have their input sent to and assessed by the central processor 140. The central processor 140 may then issue or provide warnings to the users or community as a whole on the wilting of leaves in the local territories as could be envisaged or mapped by the central processor 140. Based on the historical knowledge base constructed or formed to date, farmers will be provided with possible reasons as well. For example, the wilting of leaves could be (i) due to under-watering; (ii) due to possibility of a fungal infection caused by different types of fungi (e.g. Verticillium wilt fungus or Fusarium wilt fungus); (iii) due to possibility of one or more tomatoes spotted with virus, (iv) due to possibility of one or more tomatoes spotted with bacteria or possibility of a pests such as pests, such as stalk borers, root knot nematodes and aphids.

In another example, the system 100 may be utilized for maize cultivation in certain geographical location such as India. The agricultural resource comprises a plantation for growing maize having a size of about five hundred (500) hectares. A long term forecast comprising a calendar plan for fertilization, irrigation and pesticiding is created. Periodic correction/adjustments to generate short term forecast based on in-situ sensors and information obtained from social and community data inputs are performed.

In accordance with another aspect of the invention and with reference to FIG. 2 there is a method 200 for managing agricultural resource. An embodiment of the invention may be described in the context of partial of full use of the system 100.

The process start with inputting data into the system 100 to generate one or more long term forecast (step s210)—such as a crop cycle forecast. Such data may include user preferred crop type, geographical location, size of agricultural resources and other registration details if the user is using the system 100 for the first time. If the user is using a mobile computing device this may include providing one or more mobile identifiers such as mobile identification number (MIN) or MSISDN.

The system 100 then generates a crop cycle forecast based on the input data provided (step s212). This includes the generation of one or more fertilization plans, one or more irrigation plans, and one or more protection plans. As the crop cycle forecast is implemented, collection of both structured and unstructured data continue to take place. The next step is of receiving the data, by the system (step s214) and pre-processing (step s216) the data. The data may then be classified and labelled as different categories such as ‘soil’, ‘weather’, ‘water’, ‘sensing’, and ‘social’ (step s218). The forecast plan may then be adjusted based on the collected data (step s220) at every predetermined intervals. Non-limiting examples of such predetermined intervals may be hourly, daily, weekly.

It is to be appreciated that the generation of the long term forecast at least involve the use of the predictive module 144. The generation of short term forecast based on adjustments of long term forecast, as well as the information provided to the users via omni-channels involve the descriptive and prescriptive modules 142 and 146.

It is to be appreciated that the generation of long term forecasts and short term forecasts involve selection and arrangement of inputs requiring different expertise, detailed as follows:

a. Long term forecast: metrological and climatic sciences—seasonal weather and terrain information; agricultural science and chemistry—seed, fertilizer, crop protection methodology; sensor and image—remote sensors.

b. short term forecast: Sensor and engineering—soil, water, weather, tree/plant sensors, social media (text, audio, video, image);

c. Omni-channels: data science, computer science—SMS, e-mail delivery, chatbots.

It is to be appreciated that the system 100 can be at least partially implemented in software that can be stored on a storage medium, executed on programmed general-purpose computer in communication and/or cooperation with at least one controller and a memory unit. In some embodiments the system 100 can be implemented in a dedicated computer, a microprocessor, or the like. In these instances, the systems and methods of this invention can be implemented as a program embedded on a mobile device or personal computer, as a resource residing on one or more servers or computer workstations, as a routine embedded in a dedicated measurement system, system component, or the like.

The above is a description of embodiments of system, method and apparatus for agricultural management. It is envisioned that those skilled in the art can design alternative embodiments of this invention that falls within the scope of the invention. In particular, it is to be appreciated that features from various embodiment(s) may be combined to form one or more additional embodiments.

1. A system for managing an agricultural resource comprising an input module arranged to receive inputs from a plurality of input sources;
a central processor arranged in data communication with the input module to generate at least one long term forecast; the central processor further configured to receive inputs from selected input sources at a predetermined time to adjust a parameter of the at least one long term forecast to derive a short term forecast; and
an output module arranged in data communication with the central processor to receive the long term forecast and/or the short term forecast for decision control; the output module arranged in data communication with at least one output device.

2. The system according to claim 1, wherein the inputs comprise at least one structured input and at least one unstructured input.

3. The system according to claim 2, wherein the at least one structured input and at least one unstructured input are fused at a feature level or a decision level to form a pre-processed input.

4. The system according to claim 1, wherein the plurality of input sources comprise at least two of the following: weather sensor, soil moisture sensor, soil pH sensor, water sensor, soft sensor, terrain map, images of environment, data associated with at least one social network.

5. The system according to claim 1, wherein the parameter to be adjusted comprises at least one of the following: fertilizer application, irrigation plan, and crop protection methodology.

6. The system according to claim 1, wherein the long term decision forecast comprises at least one of the following decision parameters: seed type selection, fertilizer application, irrigation plan, crop protection.

7. The system according to claim 1, wherein the output module comprises an omni-channel interface comprising a plurality of output channels.

8. The system according to claim 8, wherein the plurality of output channels comprises two or more of the following:—short message system (SMS) message, electronic mail, web or desktop app, mobile application, application programming interface, geographical information system, chatbot.

9. The system according to claim 1, wherein the central processor comprises a descriptive module, a predictive module and a prescriptive module.

10. The system according to claim 9, wherein the descriptive module comprises at least one of the following sub module:—a visualization module, an alert module, and a reports module.

11. The system according to claim 1, wherein the long term forecast or short term forecast is generated using at least one of the following: a basic rule simulator, a classification and regression tree, and a deep learning algorithm.

12. The system according to claim 1, wherein prediction of the at least one parameter comprises one or more of the following:—soil data interpolation, hyper local weather forecast, yield estimation, pest and disease forecast.

13. The system according to claim 1, wherein the input module comprises a mobile computing device arranged to send at least one structured input or at least one unstructured input to the central processor, the mobile computing device further arranged in data communication with the at least one output device.

14. The system according to claim 1, wherein the inputs are selectively labelled for classification using an adaptive sampling methodology, the adaptive sampling methodology comprises an estimation of one or more of the following: a function, a concept, an incident.

15. A method for managing an agricultural resource comprising the steps of:
a. generating at least one long term forecast;
b. collecting at least a structured data and an unstructured data;
c. receiving and pre-processing the structured and unstructured data by a central processor, the pre-processing step further comprises classifying and labelling the structured and unstructured data; and
d. adjusting the at least one long term forecast to derive a short term forecast based on the collected data at every predetermined interval.

16. A non-transitory computer readable medium containing executable software instructions thereon wherein when executed on a mobile device and/or a computer device performs the method for agricultural management comprising the steps of:
a. generating at least one long term forecast;
b. collecting a structured data and an unstructured data;
c. receiving and pre-processing the structured and unstructured data by a central processor, the pre-processing step further comprises classifying and labelling the structured and unstructured data; and
d. adjusting the at least one long term forecast to derive a short term forecast based on the collected data at every predetermined interval.
